(19) United States
(12) Patent Application Publication
(10) Pub. No.: US 2009/0260011 A1
(43) Pub. Date: Oct. 15, 2009

(54) COMMAND LINE TRANSACTIONS

(75) Inventors: Jeffrey P. Snover, Woodinville, WA (US); Abhishek Agrawal, Seattle, WA (US); Leigh C. Holmes, Renton, WA (US); Cuneyt E. Havlioglu, Seattle, WA (US); William James Carley, Woodinville, WA (US); Vikram Sahijwani, Renton, WA (US); Vitaly Bordovskiy, Kirkland, WA (US); James Johnson, Bellevue, WA (US); Kapil Gupta, Redmond, WA (US)

Correspondence Address: WOLF GREENFIELD (Microsoft Corporation);C/O WOLF, GREENFIELD & SACKS, P.C., 600 ATLANTIC AVENUE, BOSTON, MA, 02210-2206, US

(73) Assignee: Microsoft Corporation, Redmond, WA (US)

(21) Appl. No.: 12/102,837

(22) Filed: Apr. 14, 2008

(51) Int. Cl. G06F 9/46

(52) U.S. Cl. 718/101

(57) ABSTRACT

A computer system with a command shell that supports execution of commands within transactions. The command shell responds to commands that start, complete or undo transactions. To support transactions, the command shell may maintain and provide transaction state information. The command shell may interact with a transaction manager that interfaces with resource managers that process transacted instructions within transacted task modules to commit or roll back transacted instructions from those task modules based on transaction state information maintained by the shell. Parameters associated with commands can control behavior in association with transaction process, including supporting nesting transactions and non-nested transactions and bypassing transacted processing in some instances of a command.

### BACKGROUND

In a computer system, there are instances in which a set of operations make changes to application or data state. Performing some, but not all of the related operations can place the system in an undefined or erroneous operating state. For example, in a database storing information about a retail operation, a sale of an item may give rise to a need to decrease a value in a record indicating a quantity of items in stock and to increase a value in a record indicating a quantity of units sold. It would not be appropriate to perform one of these operations if both could not be performed. As another example, when configuring a computer, multiple changes may be made to a registry file. If the configuration process were interrupted before all changes to the registry file were made, the computer could be left in an unintended operating state and would not function properly. Use of transactions make it possible that such related operations can be grouped together, so that all operations are completed or none of them are completed. The activity where these operations are grouped together is referred to as a transaction.

To achieve the intended all or none transaction semantics, a platform component of a computing system may include a “transaction manager” and a “resource manager.” These components ensure that, if all of the operations in a transaction cannot be performed together, then none of the operations are performed. SQL Server, the Windows® operating system and the NET framework, for example, may contain transaction managers and resource managers.

In one known model, the transaction manager and resource manager implement the “two phase commit protocol.” An application programmer wanting to use the platform to execute a transaction will write code as part of the application that accesses platform functions through an application programming interface to the transaction manager. The transaction manager will track the operations of the transaction and interact with the resource managers to determine whether every operation of the transaction can be performed. If so, the transaction manager will “commit” the transaction, meaning that the operations are allowed to actually affect the state of the system. If not, or if an error occurs before that check is complete, the transaction manager will “roll back” the transaction. When a transaction is rolled back, none of the operations that are part of the transaction are allowed to change the state of the resources.

### SUMMARY OF INVENTION

Significant flexibility is provided to users, including programmers and administrators, of a computer system by providing a command shell that supports transactions. The command set recognized by the command shell may include transaction commands, such as commands that start, complete or roll back transactions. These commands may be interspersed with simple commands, some of which may be transacted, that perform operations within the computer system. The transacted commands may be executed within an ambient transaction defined by the transaction commands.

With such a command shell, a user may define transactions by sequencing commands, such as by successively entering commands through a user interface or creating a script that contains a sequence of commands. For example, an administrator may create a transaction to configure the computer system, without using an application specifically designed to execute transactions.

The foregoing is a non-limiting summary of the invention, which is defined by the attached claims.

### BRIEF DESCRIPTION OF DRAWINGS

The accompanying drawings are not intended to be drawn to scale. In the drawings, each identical or nearly identical component that is illustrated in various figures is represented by a like numeral. For purposes of clarity, not every component may be labeled in every drawing. In the drawings:

FIG. 1A is an architectural block diagram of components in a computer system adapted for executing a transaction as is known in the art;

FIG. 1B is an example of a task module that may be used in a system according to some illustrative embodiments of the invention;

FIG. 1C is a sketch of an alternative embodiment of a task module that may be used in a system according to some illustrative embodiments of the invention;

FIG. 2 is an architectural block diagram of a computer system with a command shell according to embodiments of the invention;

FIG. 3 is a flow chart of a method of operating a computer system according to some illustrative embodiments of the invention;

FIG. 4A is a flow chart of processing of a start transaction command according to some illustrative embodiments of the invention;

FIG. 4B is a flow chart illustrating processing of a complete transaction command according to some illustrative embodiments of the invention;

FIG. 4C is a flow chart of a method of processing an undo transaction command according to some illustrative embodiments of the invention;

FIG. 4D is a flow chart of an illustrative method of processing a transacted command according to some embodiments of the invention; and

FIG. 5 is a sketch of a computer system in which some embodiments of the invention may operate.

### DETAILED DESCRIPTION

The inventors have appreciated that operation of a computing system could be improved if transactions could be more readily defined. Rather than limiting transactions to those performed as part of an application designed to support transactions, new transactions can be readily defined for commands specified through a command line. For example, as a computer is frequently configured by a user entering commands through a command line. These commands can be entered through a user interface or as part of a script that is executed. Regardless of how the commands are entered through the command line, there are scenarios in which it would be desirable to provide a simple mechanism for a set of such commands to be transacted. Use of transactions helps ensure that the computer is not left in an undefined or unintended operating state as a result of incomplete execution of a sequence of operations.

Moreover, because commands associated with multiple applications can be entered through a command line, providing transaction support for command line processing enables transactions that can include transactional instructions provided as part of multiple applications, even though those applications were not specifically designed to work together in a transaction.

According to some embodiments, transaction support is incorporated in a computer system through the use of a command shell that facilitates transaction processing. The command shell may resemble a command shell as known in the art. However, the command shell may respond to transaction commands, such as commands that start, complete or undo a transaction. The command shell may also receive and process simple commands, some of which may be transacted.

For greater control over definition of a transaction, the commands processed by the command shell may include parameters that define operating characteristics. For example, the command shell may support nested transactions or non-nested transactions, which may be distinguished based on parameters associated with a start transaction command.

The distinction between nested and non-nested transactions may be useful, for example, when streams of commands may be predefined and one stream of transaction may invoke another stream. If a user intends operations within the called stream to be disposed of separately from operations in the calling stream, a transaction started in the called stream may be nested with a transaction started in the calling stream. In contrast, when it is intended that all of the operations in both streams are disposed of as a single transaction, a transaction started in the called stream may be non-nested relative to a transaction started in the calling stream.

Any suitable mechanisms may be incorporated into the computer system to support transaction processing. In some embodiments, the command shell may include a transaction manager that interacts with transacted task modules to log transactional instructions in those modules and to commit them, when appropriate. Moreover, whether to log transactional instructions and when to commit them may be determined based on coding within the task modules as well as transaction-related state information maintained within the command shell. For example, conditional instructions may be defined for use in coding transacted task modules such that execution of instructions in those modules may depend on a dynamically defined transaction state.

Though embodiments of the invention will provide capabilities not heretofore provided in a computer system, these capabilities may be implemented using techniques as is known in the art. For example, platforms that execute transactions are known.

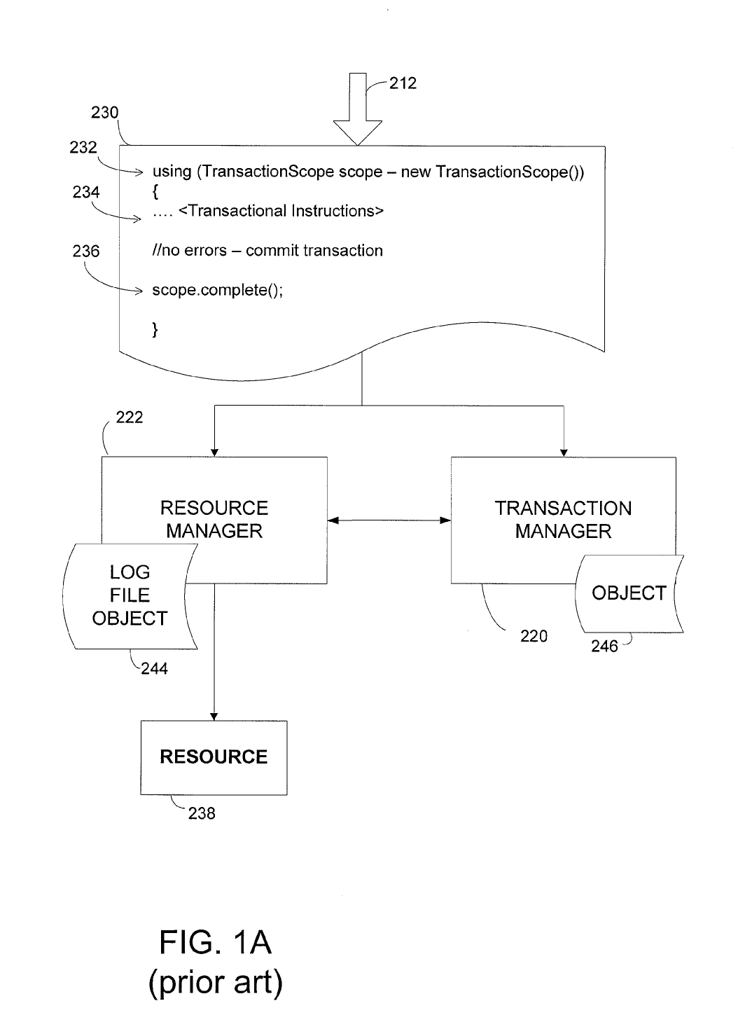

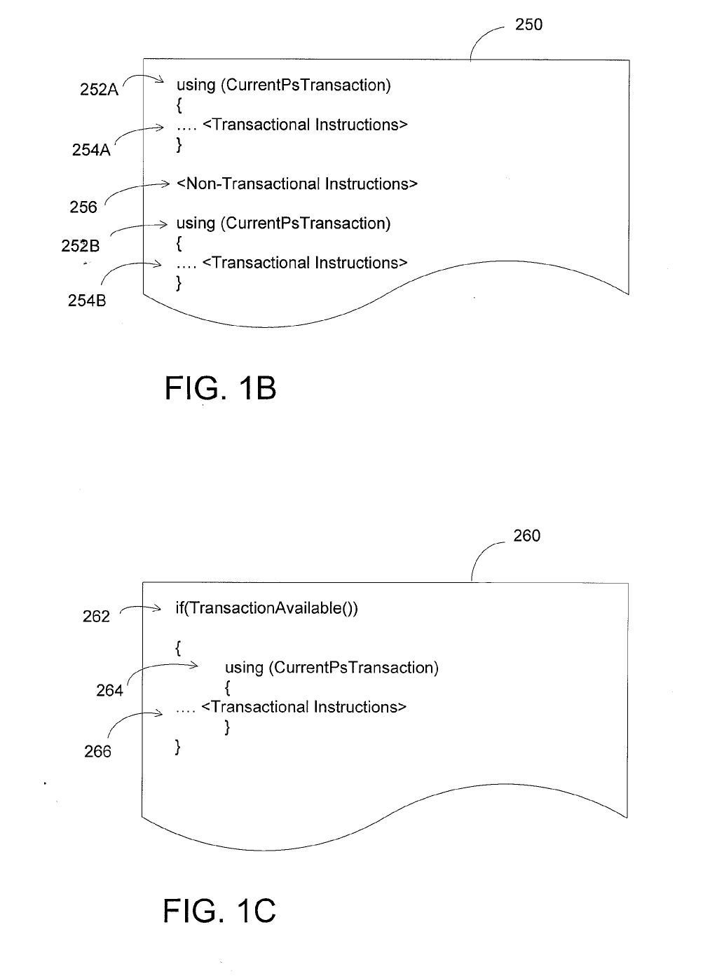

As an example of techniques and technology that may be adapted to implement transactions through a command line interface, FIG. 1A illustrates an architecture of a computer system performing transactions as is known in the art. In the example illustrated, an application 230 is constructed to perform a transaction in response to user input 212. User input 212 identifies a transaction to be performed. The format of input 212 may depend on the intended operation of application 230. For example, if application 230 is a registry component within an operating system, input 212 may identify changes to a registry key that are intended to be performed as part of configuring the computer system. Alternatively, if application 230 represents a database in an enterprise, input 212 may identify a group of changes to the database that is intended to be made together.

Regardless of the form of input 212, computer-executable instructions within application 230 may execute in response. In this example, instructions 232, 234 and 236 may be executed to perform the transaction. In the example of FIG. 1A, instructions 232 and 236 establish a transaction and signify completion of the transaction, respectively. Instructions 234 are transactional instructions. All of the changes made by transactional instructions 234 are made permanent if the transaction is completed, but are omitted if the transaction cannot be completed. In the example illustrated, transactional instructions 234 may alter the state of resource 238. In this way, the state of resource 238 is not altered unless the entire transaction can be completed.

This transactional behavior can be achieved through the interaction of application 230 with transaction manager 220 and resource manager 222. These components may interact to implement a “two phase commit protocol.” Such a transaction may be implemented as follows:
1. Application 230 receives input 212, which could be user input or another stimulus.
2. Application 230 executes instruction 232, which starts a transaction with the transaction manager 220. The transaction may be implemented as an object 246.
3. Using the transaction created in step 2, Application makes an update on resource manager 222, identifying object 246 as the transaction in progress.
4. Resource Manager 222 enlists in the transaction through transaction manager 220, resulting in a record within object 246 that resource manager 222 has participated in the transaction.
5. Application 230 processes transactional instructions 234. To process these instructions as they apply to resource 238, the instructions are applied to resource manager 222.
6. Because resource manager 222 was updated at step 3 to indicate that it is in a transaction, it does not immediately execute the instructions in a way that they change the state of resource 238. Rather, in response to each instruction, resource manager 222 makes a record of actions to be executed when the transaction is completed. This record is made in a log file object 244.
7. Upon execution of instruction 236, application 230 asks transaction manager 220 to complete the transaction.
8. Transaction Manager commits the transaction by using the Two-Phase Commit Protocol to drive completion with the Resource Manager. If the transaction can be completed, instruction 236 returns to application 230 with successful execution. Conversely, if for any reason the entire transaction could not be completed, instruction 236 returns to application 230 with an indication that the transaction was not completed.
   Two phase commit proceeds as follows:
1. Transaction manager 220 asks resource manager 222 if it can commit the transaction.
   2. Resource manager 222 uses the information in log file object 244 to determine it can execute all of the instructions recorded as part of the transaction in question and responds back to transaction manager 220 whether it can proceed with the commit.
3. If resource manager 222 indicates that it can complete the transaction, transaction manager 220 asks resource manager 222 to commit the transaction by executing the instructions it logged to actually alter the state of resource 238.
4. Transaction manager 220 tells the application 230 that the transaction is committed by returning successfully from instruction 236. Though, if the transaction could not be completed, this fact would be communicated through returning a failure indication in response to instruction 236.

In the embodiment illustrated, application 230 is implemented using a series of computer executable instructions that perform an operation as part of the transaction. In FIG. 1A, pseudo code of instructions such as may be written in the programming language C#, is pictured to represent application 230. These instructions make application 230 “transacted,” indicating that it is coded for processing within a transaction.

Though FIG. 1A illustrates a single resource 238 with a single resource manager 222, application 230 may interact with multiple resources, each having a resource manager. In this scenario, before committing a transaction, transaction manager 220 may interact with each of the resource managers to determine whether the transactional instructions intended to be applied to their corresponding resources can be completely executed without error. If so, transaction manager 220 indicates that the logged transactional instructions for all of the resources enlisted in the transaction be executed when a transaction is committed. Conversely, if any of the resource managers determines that its transactional instructions cannot be executed, transaction manager 220 may rollback the transaction. In this scenario, transaction manager 220 may discard object 246 representing the transaction and resource managers may discard the log file objects generated to hold indications of the transaction instructions, affectively “rolling back” the transaction.

The inventors have appreciated that a two phase commit protocol may be adapted to enable commands provided through a command shell to be transacted. A command shell is a known component of many computer operating systems. A shell receives input, such as through user input or from a script, that contains a sequence of instructions, sometimes called “cmdlets.” Each cmdlet identifies a set of computer-executable instructions, which is described herein as a “task module,” that, when executed perform the operations associated with the cmdlet. In some instances, a task module may invoke other cmdlets. Nonetheless, by invoking a task module in response to a cmdlet, a set of operations associated with a cmdlet may be processed.

The inventors have recognized and appreciated that an application, such as application 230, could be invoked in response to user input received through a command shell. However, simply invoking a transacted application, such as application 230, may not provide a desired behavior in all scenarios. By encoding the transactional behavior into the application, it may not be possible to dynamically specify the transactional behavior with input provided after the application is written. For example, a user may desire to create a transaction involving multiple cmdlets developed at different times by different parties. In this scenario, the desired transactional behavior, such as when to create or complete a transaction, cannot be written in advance into the application.

Accordingly, task modules that implement cmdlets to be part of a transaction defined through a command shell may be coded differently than transacted applications. Furthermore, the command shell itself may be adapted to support transactional behavior. Accordingly, in some embodiments a command shell may process cmdlets defining transactional behavior. In addition, the command shell may maintain transaction state information.

FIG. 1B shows a task module 250 adapted for execution as part of a transaction defined through a command shell. In this example, task module 250 contains multiple blocks of instructions, some of which are transactional instructions and some of which are non-transactional instructions.

In the example of FIG. 1B, instruction 252A is associated with transactional instructions 254A. Instruction 252A determines a transaction with which instructions 254A are associated. In contrast to instruction 232 within task module 230 (FIG. 1A), instruction 252A does not cause a new transaction to be created. Rather, instruction 252A indicates that the transactional instructions 254A are to be executed in the context of an ambient transaction that is defined outside of task module 250. In this example, “CurrentPsTransaction” identifies a current, or ambient, transaction maintained by a command shell. As a result, the task module 250 may be processed within the context of a transaction that is determined dynamically as task module 250 is processed, rather than when it was coded.

Other instructions within task module 250 may similarly be processed within the context of a transaction. For example, transactional instructions 254B are within a code block processed in the context of a transaction. Instruction 252B, preceding that code block, likewise identifies the transaction as one maintained by the command shell.

It is not necessary that all of the instructions within task module 250 be transactional instructions. As illustrated by the example of FIG. 1B, task module 250 may contain non-transactional instructions, such as non-transactional instructions 256.

In addition to providing the capability for instructions to be processed in the context of a transaction defined outside the task module, task module 250 differs from task module 230 (FIG. 1A) in that task module 250 contains no instruction comparable to instruction 236 (FIG. 1A) signifying the end of a transaction. As described in greater detail below, transactions processed through a command shell may start and end based on transaction commands input to the command shell. In this way, transactions may be dynamically composed from a set of cmdlets invoked through a command line interface.

FIG. 1B is just one example of a task module 250 that may be employed in conjunction with a command shell that support transactional commands, and other forms of task modules are possible. For example, FIG. 1C illustrates task module 260 that contains conditional blocks of transactional instructions. As noted above, task modules implementing cmdlets are coded without express knowledge of the transaction context in which they may be invoked. Because of the uncertainty associated with the transaction context in which a task module may be processed, instructions may be defined to allow appropriate behaviors of task modules regardless of whether they are invoked within a transaction or outside a transaction.

As illustrated in FIG. 1C, task module 260 includes a conditional instruction 262. The code block following conditional instruction 262 is processed when the condition specified in instruction 262 is satisfied. In this example, the conditional portion of instruction 262 is based on transaction processing information maintained by a command shell. Specifically, the condition of instruction 262 is met if a command shell that invoked task module 260 has a transaction available. If a transaction is available, instructions in the following code block are processed. Those instructions include instruction 264, which indicates that transactional instructions 266 are to be performed in the context of the current transaction maintained by the command shell. Conversely, if task module 260 is invoked when no transaction is available, transactional instructions 266 will not be processed.

Providing for the possibility of conditional processing instructions that are based on the state of transaction processing within a command shell allows a developer of task modules, such as task modules 250 and 260, to define behaviors that are appropriate for many circumstances and may facilitate composing transactions through a command line interface. For example, task module 250 is an appropriate encoding of operations that are performed in the context of a transaction. Invoking task module 250 in a different context where no transaction has been defined may generate an error. In contrast, invoking task module 260 in a context where no transaction has been defined will not produce an error. However, task module 260 may perform different functions based on the environment in which it is invoked.

As illustrated in FIGS. 1B and 1C, task modules may receive transaction-related state information from an external source, which is the command shell in the illustrated embodiments. For example, both task module 250 and 260 access information defining the current transaction. Such information may be maintained within the command shell in any suitable way. Likewise the information may be made accessible to task modules 250 and 260 in any suitable way. For example, when a command shell selects a task module to process, it may provide transaction state information to the task module, such as whether a transaction is in process, and, if a transaction is in process, information identifying the transaction that can be passed onto a resource manager by the task module, so that the resource manager processing instructions can enlist in the transaction.

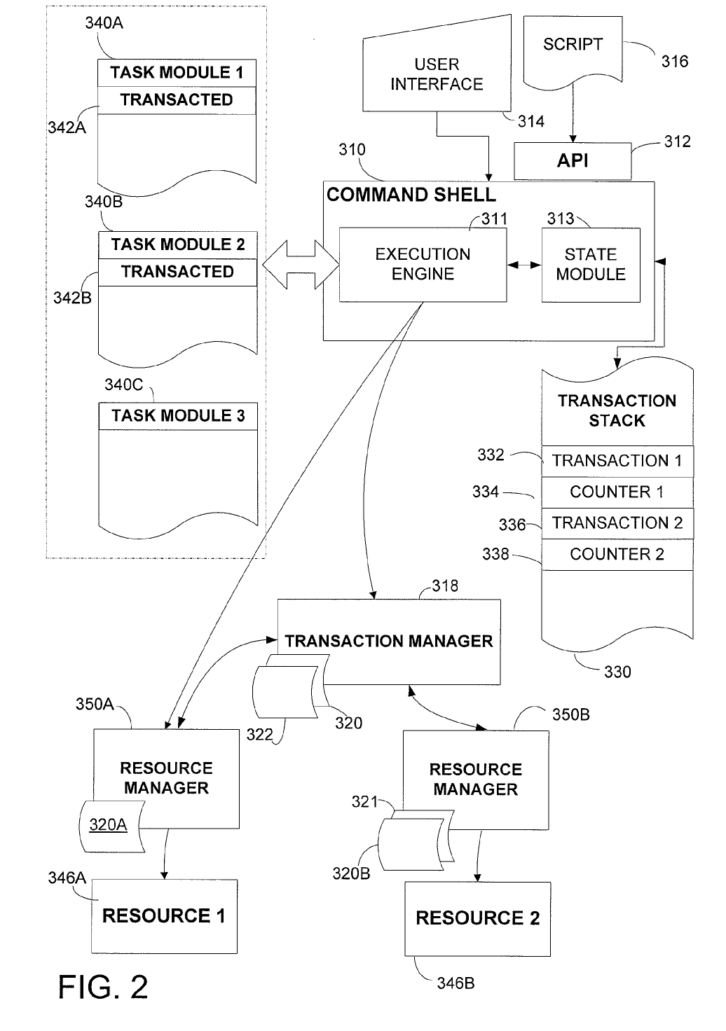

Though any suitable mechanism may be used for interactions between a command shell and one or more task modules, FIG. 2 provides an example of an architecture that may be employed.

In the example of FIG. 2, a transaction manager 318 and resource managers, such as resource managers 350A and 350B, may be used to log transactional instructions and commit them or roll them back upon disposition of a transaction. These components may be implemented using known transaction processing techniques. Though, any suitable mechanism for selectively executing instructions that are part of a transaction may be used.

FIG. 2 illustrates a command shell 310, which may be implemented using programming techniques known in the art. Command shell 310 may include one or more computer executable components that receive commands and execute them. Such computer executable components may include an execution engine 311 and a transaction state module 313.

Also, as known in the art, the commands executed by command shell 310 may be obtained from one or more sources. In this example, commands may be provided through a user interface 314. Through such a user interface, a user of a computer configured as illustrated in FIG. 2 may input commands in an order in which they are intended to be executed. A user may input commands through user interface 314 by typing commands on a computer keyboard or in any other suitable way.

As another example, commands may be input to command shell 310 through an application programming interface 312. Commands may be input through API 312 under control of script 316. Script 316 may be implemented as a series of commands typed into a file, as is known art. However, the mechanisms by which commands are input to command shell 310 are not limitations on the invention and any suitable mechanism may be used.

Command shell 310 may differ from a command shell as is known in the art in that it may be adapted to support transactions. One way in which command shell 310 may support transactions is that it may process commands that alter the state of transaction processing. Additionally, command shell 310 may interact with other components of the system in a way that implements transacted behavior consistent with the transactional commands it receives.

As a specific example, execution engine 311 within command shell 310 may process transaction commands, some of which define the start of transactions and others of which define dispositions of transactions. A transaction may be disposed of by completing the transaction, which commits all of the transactional instructions that are part of the task modules executed as part of the transaction. Though, a transaction may be disposed of in other ways, such as by undoing the transaction. In the embodiment illustrated, command shell 310 may respond to transaction commands that perform start, complete and undo transactions.

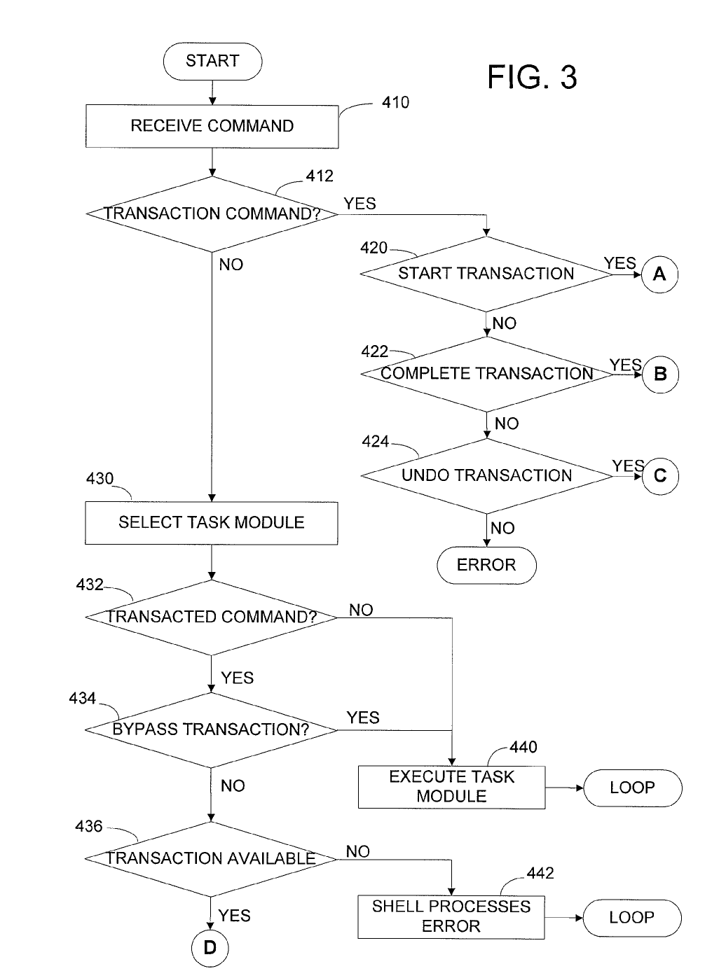

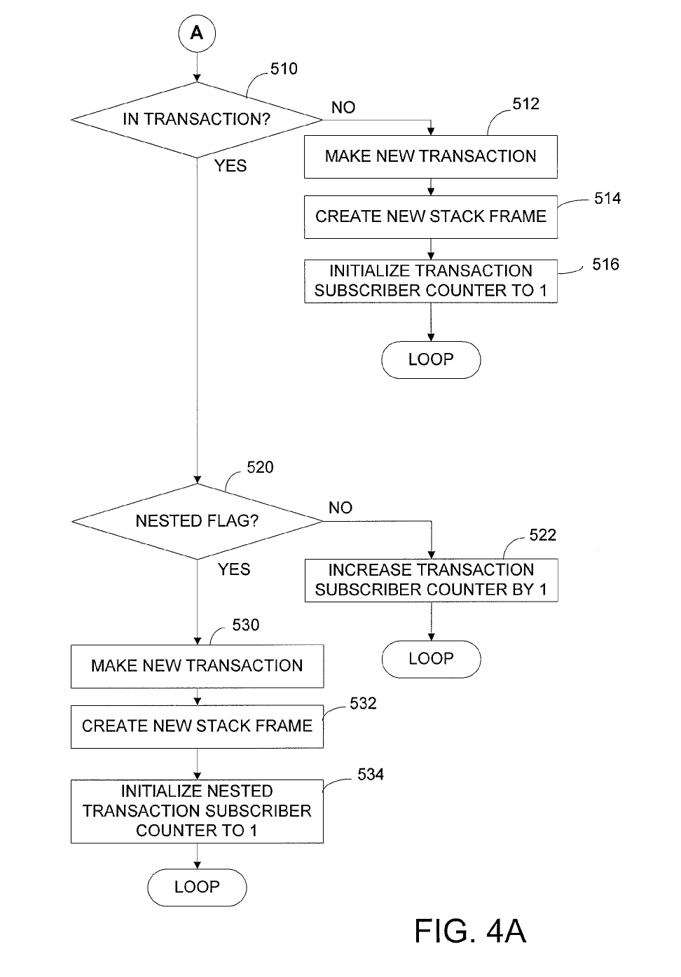

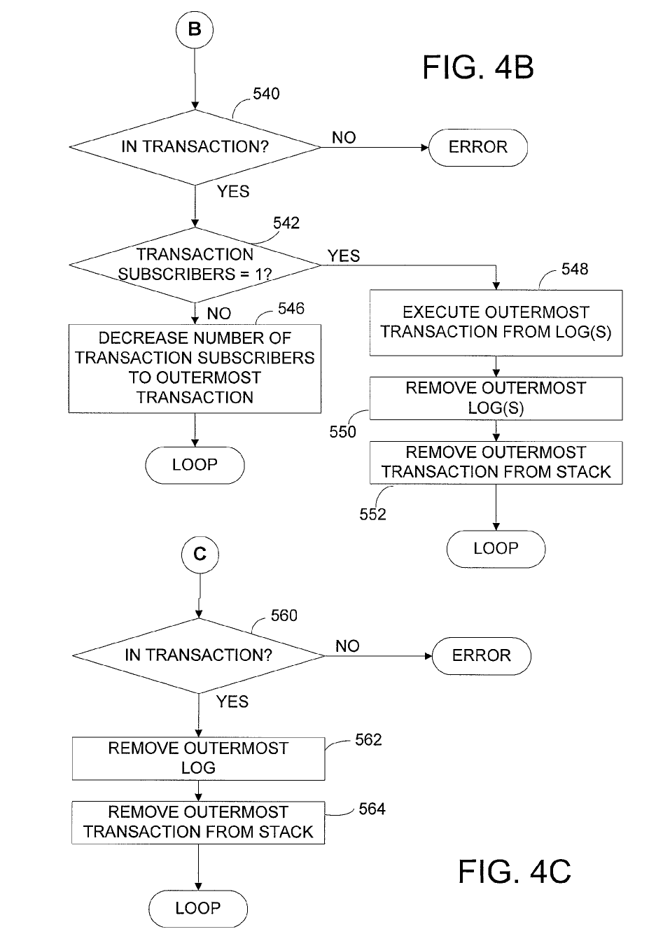

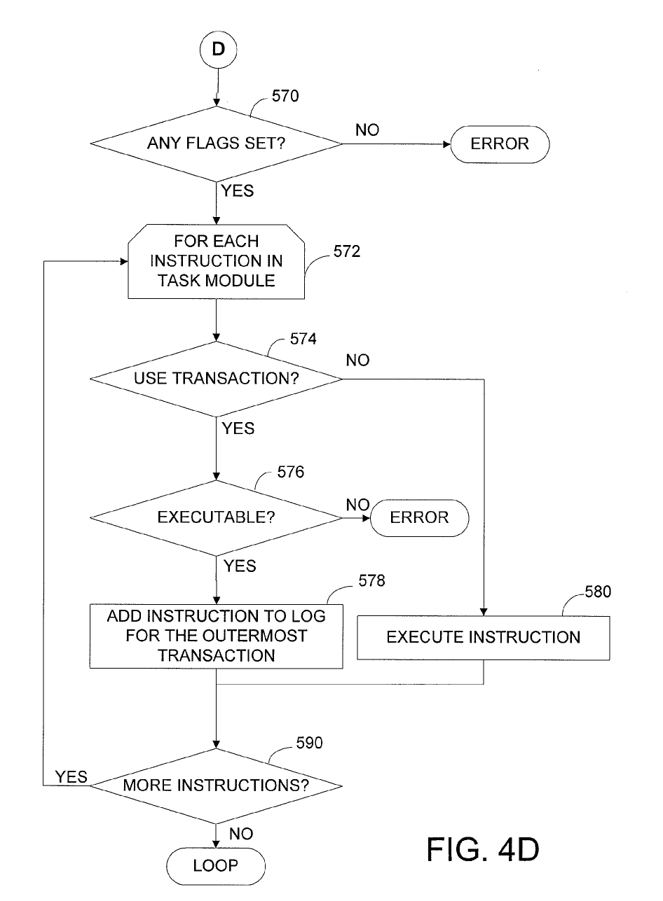

As command shell 310 responds to such transactional commands, state module 313 may record the transactional state of command shell 310. In addition, as commands are executed that depend on transactional state, state module 313 may provide state information to execution engine 311, so that the commands can be executed based on the state information. Known programming techniques may be used to enable the components depicted in FIG. 2 to exchange information, though any suitable mechanism may be used. These components may be programmed to perform processing as illustrated in more detail in conjunction with FIG. 3 and FIGS. 4A . . . 4C, as described below.

Part of the processing described below may entail creating or disposing of transactions based on changes of transactional state. Transactions may be represented using techniques as known in the art. For example transaction manager 318 may create an object 320 in response to input indicating that a transaction should be started. Object 320 may be implemented in the same fashion as object 246, though any suitable mechanism for representing a transaction may be used. However, rather than creating such an object in response to an instruction from an application, transaction manager 318 may create such an object in response to a command from command shell 310.

In some embodiments illustrated, transactions may be nested, creating the possibility that multiple transactions may be defined at one time. Accordingly, FIG. 2 indicates that transaction manager 318 may create more than one object, and a second object 322 is illustrated in FIG. 2. To maintain state information about each transaction, transaction stack 330 may be used.

Transaction stack 330 may be maintained by a stack module within command shell 310 or in any other suitable way. The stack 330 may be implemented as a data structure in computer-readable media associated with a computer on which command shell 310 resides. However, any suitable mechanism may be used to implement transaction stack 330.

Transaction stack 330 may include a frame for each transaction in existence. In this example, identifier 332 and counter 334 form a first frame and identifier 336 and counter 338 form a second frame, each associated with one of the transactions. Accordingly, command shell 310 may add and remove such frames as transactions are created or disposed of. Command shell may use the frame at the top of stack 330 to identify the current, or ambient, transaction.

When command shell 310 executes a transactional command that completes a transaction, it may notify transaction manager 318. Transaction manager 318 may then commit the transaction by interacting with resource mangers, such as resource managers 350A and 350B. These interactions may be performed according to a two phase commit protocol as known in the art. However, any suitable processing to complete a transaction may be used.

Command shell 310 may also process simple commands that access resources or perform other actions within a computer system. The simple commands may be analogous to those performed by a command shell as is known in the art. Though, simple commands may be processed according to a process described in more detail in connection with FIG. 3 and FIG. 4D, as described below. The simple commands may be processed by invoking either non-transacted task modules as are known in the art or by invoking transacted task modules as described above in connection with FIGS. 1B and 1C.

When task modules include transactional instructions that are to be processed based on the current transactional state of the system, those transactional instructions may be processed using techniques as are known in the art. For example, a transaction manager 318 and resource managers 350A and 350B may be used to identify transactional instructions and execute them or roll them back upon disposition of a transaction. Though, any suitable mechanism for selectively executing instructions that are part of a transaction may be used.

Transaction manager 318 may interact with resources managers, such as resource managers 350A and 350B, to process task modules that may be transacted. In the example of FIG. 2, task modules 340A and 340B are transacted task modules. However, the example of FIG. 2 illustrates that it is not necessary for all of the task modules invoked in response to commands processed by command shell 310 be transacted. As a specific example, task module 340C is indicated to be a non-transacted module, containing no transactional instructions. Thus, the processing steps performed within command shell 310 in response to an input command may depend on the nature of the command, including whether it is transacted.

In the example illustrated, simple, non-transacted commands may be processed in the same way that known command shells process commands. Specifically, when a cmdlet implemented by a non-transacted task module, such as task module 340C, is processed, the task module may be invoked without receiving or altering transactional state information. Any instructions within task module 340C may be executed when the module is invoked, even if those instructions alter the state of resource 346B upon which task module 340C operates.

When command shell 310 processes a cmdlet implemented as a transacted task module, shell 310 may provide the task module with information on the current transaction. This information may be provided in any suitable way. For example, execution of an instruction, such as instruction 252A (FIG. 1B) may result in this information being available to the task module. The task module then has the same information about a transaction that is available to a transacted application 230 (FIG. 1A).

The information about the current transaction may be used to log transactional instructions in a resource manager and associate those instructions with a transaction. Each resource manager, such as resource mangers 350A and 350B, that processes transactional instructions in a task module may be provided with an indication of the current transaction. The resource manager can then enlist in that transaction, log the instructions for execution, and permanently apply the updates done in the transaction if that transaction is committed.

In the example of FIG. 2, logs 320A and 320B are shown associated with resource mangers 350A and 350B. Logs 320A and 320B may be in the same form as log 244 (FIG. 1A), though any suitable implementation may be used. Because more than one transaction can exist at one time, resource managers may log instructions in a way to separate instructions processed in the context of different transactions. This capability could be provided by separate logs, such as logs 320B and 321 maintained by resource manager 350B. However, any suitable mechanism for logging instructions in connection with different transactions may be employed.

To enable command shell 310 to distinguish between transacted task modules and non-transacted task modules, a mechanism may be incorporated to identify transacted task modules. In this example, the transacted task modules 340A and 340B are coded with a flag, illustrated as flags 342A and 342B, respectively. Command shell 310 may ascertain whether a task module that is to be invoked in response to processing a command is transacted. As one example, each task module may expose an interface through which a transacted flag may be read, if such a flag is present. Though, other mechanisms may be used to identify a transacted task module. For example, a flag may be associated with a command provided to command shell 310 which, when executed, is intended to invoke a task module. Accordingly, the specific mechanism by which transacted task modules are identified is not critical to the invention.

FIG. 3 is a flowchart illustrating processing of a command within the system of FIG. 2. However, the process illustrated in FIG. 3 may be implemented in any suitable way.

Regardless of the specific implementation, the process of FIG. 3 begins at block 410 where a command is received. In the example of FIG. 2, commands may be received at command shell 310 from a user interface or a script file. The received command may represent a single command in a series of commands that collectively implement a transaction or other operations. In that scenario, the process of FIG. 3 may be repeated for each command in the series. However, the specific mechanism by which a command is received is not critical to the invention and any suitable mechanism may be used.

Once the command is received, processing proceeds to decision block 412. At decision block 412 the process branches depending on whether the received command is a transaction command. In the example of FIG. 3, command shell 310 may process start, complete or undo transaction commands. In contrast to simple commands, which operate on resources or otherwise perform an operation, transaction commands alter the state of command processing within command shell 310. Though three such transaction commands are illustrated, the specific number and type of transaction commands recognized by command shell 310 is not critical to the invention.

Any suitable mechanism may be used to allow shell 310 to identify transaction commands. As one example, each command may include a unique identifier. Command shell 310 may include a mapping table or other suitable mechanism to select, based on command identifiers, those commands that are transaction commands.

Regardless of the mechanism by which transaction commands are identified, when a transaction command is received, processing may branch from decision block 412 to decision block 420. At decision block 420, the process may again branch based on whether the received command indicates that a transaction should be started. If the received command indicates the start of the transaction, the process branches to perform subprocess A, which is described in more detail in conjunction with FIG. 4A below.

Conversely, if the received command is not a start transaction command, the process proceeds to decision block 422. At decision block 422, the process again branches depending on whether the received command is a complete transaction command. If the received command is a complete transaction command, the process proceeds to subprocess B, described in more detail below in conjunction with FIG. 4B.

If the received command is not a complete transaction command, the process proceeds to decision block 424. At decision block 424, the process again branches depending on whether the received command is an undo command. If the received command is an undo command, the process proceeds to subprocess C, described in more detail in conjunction with FIG. 4C below.

In the embodiment illustrated, command shell 310 supports three transaction commands, start, complete and undo. Accordingly, if the process exits decision block 424 without being diverted to one of subprocesses A, B or C, then an error has occurred. Accordingly, if, as determined at decision block 424, the received command is not an undo command, the process ends at an error termination point. Such processing is appropriate when only the three described transaction commands are supported within command shell 310. If command shell 310 supports other transaction commands, other decision processing may be performed to determine whether the received command corresponds with a supported transaction command before error processing begins.

Returning to decision block 412, if it is determined at decision block 412 that the received command is not a transaction command, the process branches from decision block 412 to block 430. At block 430, command shell 310 may select a task module containing instructions implementing the command. A conventional command shell may invoke a task module in response to a received command. A similar mechanism may be employed for transaction processing as described herein. In this case, each task module may be in the form of task modules such as task module 250 (FIG. 1B) or task module 260 (FIG. 1C), though any suitable implementation may be used. A task module may be selected at block 430 based on an identifier associated with the received command, though any suitable mechanism to select the task module may be used.

Regardless of how the task module is selected, the processing may proceed to decision block 432. At decision block 432, the process may branch depending on whether the selected task module is transacted. As described above in connection with FIG. 2, flags or other indicators may be associated with task modules to allow command shell 310 to determine whether a specific command should be processed in the context of a transaction.

If a received command, or the selected task module that will execute it, is not indicated to be transacted, the processing branches from decision block 432 to block 440. At block 440, the task module is executed. If processing reaches block 440, the task module is not executed within a transaction. Accordingly, processing at block 440 may be performed as is known in the art for executing a task module invoked by a command shell. Thereafter, processing may loop back to the start of the process illustrated in FIG. 3 where another command may be received and processed.

If the selected task module is transacted, however, processing may branch from decision block 432 to decision block 434. At decision block 434, the process may again branch based on whether transactional behavior is to be bypassed. In the example of FIG. 3, decision block 434 determines whether an indication has been received to bypass transactional processing for the selected task module. In the example illustrated in which cmdlets are implemented without being tied to a specific transaction, it may be desirable to incorporate a mechanism by which the task module may be controlled to, in some circumstances, have transactional behavior and in other circumstances have non-transactional behavior. One such mechanism that may be employed is a bypass flag that may be optionally associated with a command or a task module invoked in response to a command. Though, such a flag may be associated with an entire script or specified in any other suitable way.

When the bypass flag set, processing may branch from decision block 434 to block 440. As described above, if processing reaches block 440, the selected cmdlet may be executed without transactional behavior. When bypassed, rather than logging instructions for later execution, each instruction may be executed as processed. Though, any other suitable behavior may be implemented when a transaction is bypassed, including processing the task module as if it were invoked in a context in which no transaction is defined, which may produce an error if the task module includes instructions that require a transaction.

Conversely, if the bypass flag is not set, processing may proceed to decision block 436. If processing reaches decision block 436, the selected cmdlet is implemented as a transacted task module intended to be executed with transactional behavior. However, if no transaction has been defined by command shell 310, the task module may not execute appropriately. Accordingly, in the embodiment illustrated, processing branches from decision block 436 to block 442 if no transaction is available within which to execute the transacted task module.

At block 442, error processing is performed. Any suitable error processing may be performed at block 442. For example, the error processing may entail generating an error message to a user or taking other corrective action. Thereafter, processing may loop back to the start of the process illustrated in FIG. 3 where further commands may be received and executed.

However, if a transaction is available, the selected cmdlet is executed within the context of that transaction. Such processing is described below in further detail in conjunction with FIG. 4D.

Turning to FIG. 4A, processing of a start transaction command according to some embodiments is illustrated. The processing of FIG. 4A is shown to begin at decision block 510. At decision block 510, processing branches depending on whether command shell 310 is currently in a state in which a transaction is active. In the embodiment of FIG. 2, a state in which a transaction is active may be determined based on the information at the top of transaction stack 330. If a frame exists on transaction stack 330 identifying a transaction, then command shell 310 may be deemed to be in a transaction. However, any suitable mechanism may be used to track the state of command shell 310 and any suitable mechanism may be used at decision block 510 to determine whether command shell 310 is in a transaction.

Regardless of how the state of command shell 310 is determined, processing branches to block 512 when command shell 310 is not in a transaction. At block 512, processing that places command shell 310 in a state for processing transacted commands is initiated. At block 512, command shell 310 indicates to transaction manager 318 that a new transaction is required and transaction manager 318 creates an object, such as object 320 or 322 to represent that transaction.

The process then proceeds to block 514 where a mechanism to track the current transaction state of command shell 310 is implemented. In the embodiment of FIG. 2, transactional state is maintained within a transaction stack 330. A new stack frame is created to store state information relating to the newly-started transaction. A frame may be created at block 514, for example, by allocating space within transaction stack 330 and storing an identifier, such as identifier 332, for the transaction created at block 512.

Other information used in implementing transactions within command shell 310 may likewise be stored within the stack. For example, at block 516 a counter, such as counter 334 may be initialized. In this example, the counter is initialized to a value of one. As described in greater detail below, this counter may be used to aid in grouping instructions from different task modules into a single transaction when such behavior is desired.

Though not expressly shown, different or additional information may also be stored in the stack frame associated with the new transaction. Regardless of the specific information stored, once the state of command shell 310 is altered to indicate that a transaction is in process, the processing of FIG. 4A may be completed and the process may loop back to the start of the process of FIG. 3, where another command may be received and processed.

Alternatively, if a start transaction command is received when command shell 310 is already in a transaction, processing may branch from decision block 510 to decision block 520. The processing branches at decision block 520 depending on the type of nesting behavior specified for the commands being processed.

In the example illustrated, command shell 310 processes two types of start transaction commands: nested or non-nested. These different types of transactions provide different behaviors when a script, encoded to support a transaction, calls another second script, also encoded to support a transaction. In some instances, the commands in the second script may be intended to be treated as a transaction separate from the commands in the calling series. In this scenario, the two scripts may be regarded as defining nested transactions, with the series of commands in the second script being disposed of separately from the series of commands in the first script. If both scripts are intended to be executed together as one transaction, the scripts should be specified non-nested.

Any suitable mechanism may be used to differentiate between a nested and a non-nested start transaction command. In this example, a flag may be incorporated in the start transaction command to indicate whether the transaction to be started is intended to be nested or non-nested. In such an embodiment, processing at block 520 may entail checking for such a flag associated with the received start command to be processed. However, separate nested and non-nested commands may be defined or the distinction may be presented in any suitable way.

Regardless of the specific mechanism used to identify whether the transaction being started is intended to be nested, if the transaction is non-nested, processing branches from decision block 520 to block 522. At block 522, the transaction subscriber counter associated with the current transaction is increased by one. In the example of FIG. 2 in which counter 338 is associated with the stack frame of the current transaction, increasing subscriber counter by one results in an increase in counter 338.

In the embodiment illustrated, the subscriber counter indicates the number of start transaction commands executed within successive non-nested transactions. In the embodiment illustrated, start and complete transaction commands are intended to be implemented in pairs. Thus, while new transactions are not being nested, the number of start transaction commands executed is an indication of the number of complete transaction commands that must be executed to reach the complete transaction command that signals the end of the non-nested transactions.

Conversely, if the start transaction command being processed in FIG. 4A is nested, processing branches from decision block 520 to block 530. Block 530 is the beginning of processing to set command shell 310 in a state in which it is processing a nested transaction. Similar to processing at block 512, at block 530 a new transaction is started and associated with the nested transaction to be established as a result of processing the start transaction command as illustrated in FIG. 4A.

A new stack frame may be created for the nested transaction at block 532. Creating the stack frame will indicate to command shell 310, and any task modules obtaining state information relating to transaction processing within command shell 310, that the current transaction is the new nested transaction established as a result of executing the start transaction command. In the embodiment in which a stack frame includes a subscriber counter, processing within FIG. 4A may additionally include initializing the subscriber counter to one, which may be performed at block 534.

As noted above, different or additional information may be stored to reflect the state of command shell 310, and the processing illustrated in FIG. 4A is illustrative rather than limiting. Regardless of the specific processing steps when command shell 310 processes a start transaction command, once those steps are complete, processing may loop back to the beginning of the process illustrated in FIG. 3 where the next command may be received and then processed.

Turning to FIG. 4B, processing that may be implemented in response to receiving a complete transaction command is illustrated. Processing in FIG. 4B begins at decision block 540. At decision block 540, the process branches, depending on whether command shell 310 is in a state in which it is processing received commands as part of a transaction. If command shell 310 is not in a transaction, then a complete command represents an improper command. Accordingly, FIG. 4B shows the process branching from decision block 540 to an error termination point when a complete transaction command is received while no transaction is in process. Any suitable error processing may be performed in response, which may include presenting an error message to a user or other suitable action.

Conversely, if the complete transaction command is received while a transaction is in process, the process proceeds from decision block 540 to decision block 542. At decision block 542, the process branches, depending on the subscriber count associated with the current transaction. In the embodiment illustrated in FIG. 2, a subscriber count may be determined from a counter associated with the top most frame of transaction stack 330.

As described above, the subscriber counter is used to determine whether the last complete transaction command in a non-nested transaction has been reached. In the embodiment illustrated, a subscriber count of one indicates that the last complete transaction command has been reached and the transactional instructions that have been logged with the current transaction should be committed. Accordingly, processing branches from decision block 542 to block 548, which is the start of processing to commit logged transactional instructions.

At block 548, transaction manager 318 begins the process of committing the instructions associated with the outermost transaction. This processing may be performed in any suitable way. However, in the embodiment illustrated a two phase commit protocol is used. As part of this protocol, transaction manager 318 may obtain information about the outermost transaction from an object, such as object 322. That information may include the resource managers that have enlisted in the transaction. Transaction manager 318 may then use this information to poll the enlisted resource managers to determine whether the transaction can be committed. If so, transaction manager 318 may indicate to the resource managers that the instructions they have logged in the context of the outermost transaction should be executed. In the example of FIG. 2, instructions in logs 320A and 320B may be executed. Instructions in log 321, associated with a different transaction are not executed. Execution of logged instructions may be performed by resource managers 350A and 250B using techniques known in the art or in any other suitable way.

Regardless of the manner in which the logged instructions are executed, processing proceeds to block 550. Because the logged instructions have been executed, the logs may be removed from the system. However, removing the log is not critical to the invention. Alternatively or additionally, the log may be archived or otherwise left as part of the computer system in which transaction processing occurs.

Processing then proceeds to block 552 where the stack frame associated with the transaction that was completed by executing instructions at block 548 is removed from the stack. The stack frame may be removed using known stack management principles or in any other suitable way.

Once operations associated with committing the instructions of the transaction have been performed, processing may loop back to the start of processing illustrated in FIG. 3 where further commands may be received and processed.

Conversely, if the subscriber counter is greater than one, processing branches from decision block 542 to block 546. As described above, the subscriber counter associated with each transaction is used as a mechanism to determine whether a complete transaction command indicates the end of non-nested transaction. If the subscriber counter is greater than one, the end of the non-nested transaction has not been reached. At block 546, the subscriber counter is decreased by one. However, the transactional commands associated with the active transaction are not committed. Accordingly, following block 546, processing may loop back to the start of the processing illustrated in FIG. 3.

Turning to FIG. 4C, processing associated with the execution of an undo command is illustrated. The processing of FIG. 4C may be performed using techniques as known in the art to rollback a transaction, though any suitable processing may be used. In the example of FIG. 4C, processing begins at decision block 560. At decision block 560, processing branches depending on whether command shell 310 is in a transaction when the undo transaction command is received. If command shell 310 is not in a transaction, then the undo transaction command may be regarded as improper. Accordingly, if command shell 310 is not in a transaction, processing branches from decision block 560 to an error termination point. Any suitable error processing may be performed.

However, if command shell 310 is processing a transaction, the process may branch from decision block 560 to block 562. Block 562 may represent the beginning of processing to roll-back the transaction to be undone. In the example in which transactions may be nested, execution of an undo transaction command results in the outermost transaction being undone. As indicated, such processing includes removing the logs associated with the outermost transaction at block 562. This action may be directed by transaction manager 318, which maintains a record of resource managers that have enlisted in each transaction.

At block 564, the stack frame associated with the outermost transaction, the transaction being undone, is also removed. The processing at blocks 562 and 564 is performed without executing the logged instructions. In this way, the transactional instructions that were part of the undone transaction do not alter the underlying resources. Once these actions are taken, processing may loop back to the start of processing of FIG. 3, where further commands may be received and processed.

Turning to FIG. 4D, processing performed on a simple transacted command is illustrated. In the example of FIG. 4D, processing begins at decision block 570. At decision block 570, the process branches depending on whether any flags are set in the command being processed. In the embodiment illustrated, command shell 310 may process commands differently, depending on parameters associated with those commands, to allow a programmer or other user to specify a sequence of commands suitable for any of a wide range of desired operating behaviors. In this example, flags may be associated with commands to alter the manner in which those commands are processed. As indicated above, a flag may indicate whether a command is intended to be transacted or may indicate whether the transacted portions of the command are to be bypassed in a specific instance.

In implementations in which each command being processed as a transacted command should have at least one flag set, a command received with no flags set may indicate an error. In the embodiment of FIG. 4D, if such a command is received, the process branches from decision block 570 to an error handler. Upon execution of the error handler, an error message may be displayed to a user or other suitable action may be taken.

If no error is detected at decision block 570, processing proceeds to loop start 572. Within the loop following loop start 572, each instruction within the task module selected at block 430 is processed. Processing within the loop begins at decision block 574. At decision block 574, the process branches depending on whether the instruction is within a block for which a transaction is to be used. For example, in FIG. 1B, non-transactional instructions 256 are not in a block in which a transaction is intended to be used. In contrast, a transaction is intended to be used for the transactional instructions 254A and 254B. In the embodiment illustrated, whether a transaction is to be used is determined based on the instructions used to implement the task module associated with the selected cmdlet. However, determination of whether a specific instruction within a task module is a transactional instruction may be determined in any suitable way.

Regardless of the manner in which transactional instructions are identified, if an instruction is not transactional, the process branches to block 580. At block 580, the instruction may be executed. Processing at block 580 may entail execution of an instruction using techniques as are known in the art or in any other suitable way.

Regardless of the manner in which the instruction is executed, following execution processing may proceed to decision block 590. At decision block 590 the process loops back to loop start 572 if additional instructions within the task module remain for processing. Conversely, if no further instructions remain, the process may branch from decision block 590 back to the start of the loop at the beginning of processing in FIG. 3 where further commands may be received and processed.

Conversely, when an instruction within a task module is intended to be executed as part of a transaction, the process of FIG. 4D branches from decision block 574 to block 576. At decision block 576, the process may again branch, depending on whether the instruction being processed is executable. The executability of a command may be determined by a resource manager as known in the art or in any other suitable way.

If the instruction is executable, the instruction is added to the log for the current transaction kept by the resource manager. In the embodiment of FIG. 2 where transactions may be nested, the current transaction is the outermost transaction as indicated by the contents of transaction stack 330. The identity of the outermost transaction may be supplied by command shell 310 when a task module is invoked. This information may be available to each resource manager that processes transactional instructions within the task module, such that the resource manager can enlist in the identified transaction and maintain a log of instructions for execution within that transaction. However, any suitable mechanism may be used to determine the transaction with which the instruction is to be associated.

In the system of FIG. 2, logging an instruction may be done using processing according to techniques known in the art for implementing two-phase commit processing, such as by adding the instruction to a log file object. However, any suitable mechanism may be used to log an instruction for execution as part of a transaction.

Regardless of the manner in which the instruction is logged, processing may then proceed to decision block 590. At decision block 590, the process may branch depending on whether further instructions remain for execution of the selected cmdlet. If so, the process loops back to loop start 572. If not, processing returns to the start of processing indicated in FIG. 3, where further commands may be received and processed. Processing may proceed in this fashion allowing commands, as defined by user input or in a script, to be executed with transactional behavior specified separately from the cmdlets or any specific application program. Rather, the transactional behavior may change dynamically, based on user input through user interface 314 (FIG. 2) or the contents of a script 316.

Though not illustrated in FIG. 4D, if an error occurs while a transaction is pending, including an attempt to complete a transaction, the system may be adapted to respond so as to ensure that the state of the system is not corrupted. In the embodiment illustrated, upon an error, all pending transactions are rolled back. Any suitable implementation may be used to achieve this result. As one example, processing as illustrated in FIG. 4D may be implemented in a try region associated with command shell 310. An error at any stage of processing of modules that are intended to be transacted may cause an exception. Such an exception may be trapped by a handler associated with command shell 310. Such a handler may be constructed to undo any transaction processing then pending. Though, any suitable mechanism may be used to respond to such an error. Additionally, such an exception may be propagated outside of command shell 310, allowing other actions to be taken in response to a transaction that did not complete properly, including notifying a user or logging the error.

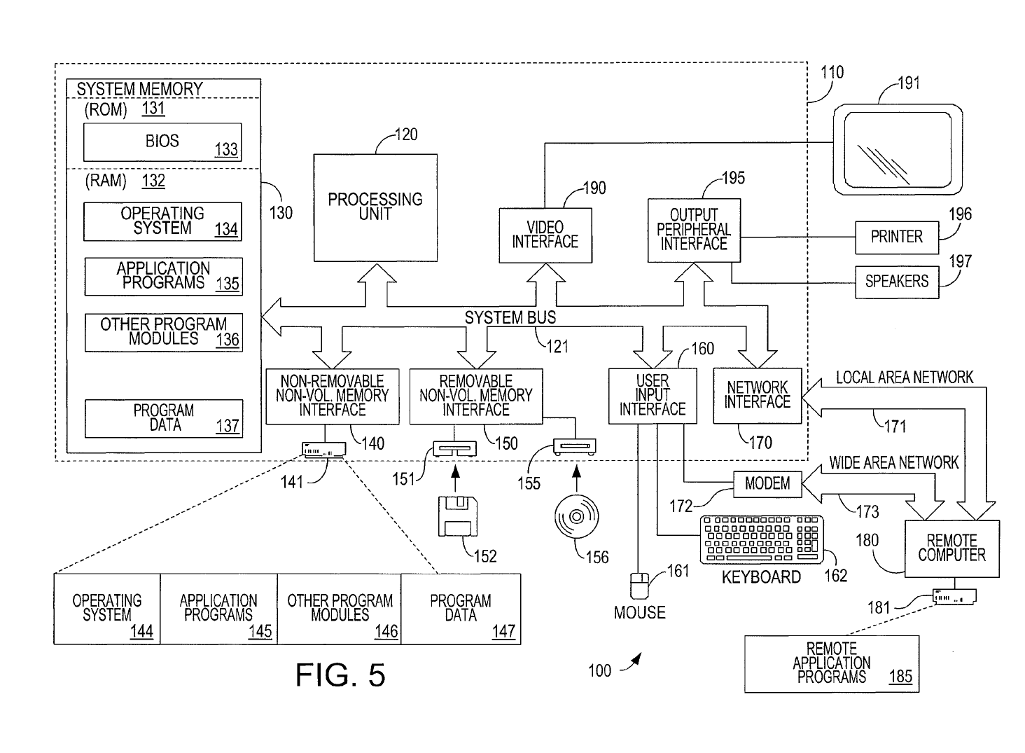

Command line processing of transactions may be implemented in any suitable computer environment. FIG. 5 illustrates an example of a suitable computing system environment 100 on which the invention may be implemented. The computing system environment 100 is only one example of a suitable computing environment and is not intended to suggest any limitation as to the scope of use or functionality of the invention.

Neither should the computing environment 100 be interpreted as having any dependency or requirement relating to any one or combination of components illustrated in the exemplary operating environment 100.

The invention is operational with numerous other general purpose or special purpose computing system environments or configurations. Examples of well known computing systems, environments, and/or configurations that may be suitable for use with the invention include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

The invention may be described in the general context of computer-executable instructions, such as program modules, being executed by a computer. Generally, program modules include routines, programs, objects, components, data structures, etc. that perform particular tasks or implement particular abstract data types. The invention may also be practiced in distributed computing environments where tasks are performed by remote processing devices that are linked through a communications network. In a distributed computing environment, program modules may be located in both local and remote computer storage media including memory storage devices.

With reference to FIG. 5, an exemplary system for implementing the invention includes a general purpose computing device in the form of a computer 110. Components of computer 110 may include, but are not limited to, a processing unit 120, a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 110 typically includes a variety of computer readable media. Computer readable media can be any available media that can be accessed by computer 110 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by computer 110. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media.

The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 5 illustrates operating system 134, application programs 135, other program modules 136, and program data 137.

The computer 110 may also include other removable/non-removable, volatile/nonvolatile computer storage media. By way of example only, FIG. 5 illustrates a hard disk drive 140 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 141 is typically connected to the system bus 121 through an non-removable memory interface such as interface 140, and magnetic disk drive 151 and optical disk drive 155 are typically connected to the system bus 121 by a removable memory interface, such as interface 150.

The drives and their associated computer storage media discussed above and illustrated in FIG. 5, provide storage of computer readable instructions, data structures, program modules and other data for the computer 110. In FIG. 5, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers here to illustrate that, at a minimum, they are different copies. A user may enter commands and information into the computer 110 through input devices such as a keyboard 162 and pointing device 161, commonly referred to as a mouse, trackball or touch pad. Other input devices (not shown) may include a microphone, joystick, game pad, satellite dish, scanner, or the like. These and other input devices are often connected to the processing unit 120 through a user input interface 160 that is coupled to the system bus, but may be connected by other interface and bus structures, such as a parallel port, game port or a universal serial bus (USB). A monitor 191 or other type of display device is also connected to the system bus 121 via an interface, such as a video interface 190. In addition to the monitor, computers may also include other peripheral output devices such as speakers 197 and printer 196, which may be connected through a output peripheral interface 195.

The computer 110 may operate in a networked environment using logical connections to one or more remote computers, such as a remote computer 180. The remote computer 180 may be a personal computer, a server, a router, a network PC, a peer device or other common network node, and typically includes many or all of the elements described above relative to the computer 110, although only a memory storage device 181 has been illustrated in FIG. 5. The logical connections depicted in FIG. 5 include a local area network (LAN) 171 and a wide area network (WAN) 173, but may also include other networks. Such networking environments are commonplace in offices, enterprise-wide computer networks, intranets and the Internet.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the user input interface 160, or other appropriate mechanism. In a networked environment, program modules depicted relative to the computer 110, or portions thereof, may be stored in the remote memory storage device. By way of example, and not limitation, FIG. 5 illustrates remote application programs 185 as residing on memory device 181. It will be appreciated that the network connections shown are exemplary and other means of establishing a communications link between the computers may be used.

Having thus described several aspects of at least one embodiment of this invention, it is to be appreciated that various alterations, modifications, and improvements will readily occur to those skilled in the art.

Such alterations, modifications, and improvements are intended to be part of this disclosure, and are intended to be within the spirit and scope of the invention. Accordingly, the foregoing description and drawings are by way of example only.

The above-described embodiments of the present invention can be implemented in any of numerous ways. For example, the embodiments may be implemented using hardware, software or a combination thereof. When implemented in software, the software code can be executed on any suitable processor or collection of processors, whether provided in a single computer or distributed among multiple computers.

Further, it should be appreciated that a computer may be embodied in any of a number of forms, such as a rack-mounted computer, a desktop computer, a laptop computer, or a tablet computer. Additionally, a computer may be embedded in a device not generally regarded as a computer but with suitable processing capabilities, including a Personal Digital Assistant (PDA), a smart phone or any other suitable portable or fixed electronic device.

Also, a computer may have one or more input and output devices. These devices can be used, among other things, to present a user interface. Examples of output devices that can be used to provide a user interface include printers or display screens for visual presentation of output and speakers or other sound generating devices for audible presentation of output. Examples of input devices that can be used for a user interface include keyboards, and pointing devices, such as mice, touch pads, and digitizing tablets. As another example, a computer may receive input information through speech recognition or in other audible format.

Such computers may be interconnected by one or more networks in any suitable form, including as a local area network or a wide area network, such as an enterprise network or the Internet. Such networks may be based on any suitable technology and may operate according to any suitable protocol and may include wireless networks, wired networks or fiber optic networks.

Also, the various methods or processes outlined herein may be coded as software that is executable on one or more processors that employ any one of a variety of operating systems or platforms. Additionally, such software may be written using any of a number of suitable programming languages and/or programming or scripting tools, and also may be compiled as executable machine language code or intermediate code that is executed on a framework or virtual machine.

In this respect, the invention may be embodied as a computer readable medium (or multiple computer readable media) (e.g., a computer memory, one or more floppy discs, compact discs, optical discs, magnetic tapes, flash memories, circuit configurations in Field Programmable Gate Arrays or other semiconductor devices, or other tangible computer storage medium) encoded with one or more programs that, when executed on one or more computers or other processors, perform methods that implement the various embodiments of the invention discussed above. The computer readable medium or media can be transportable, such that the program or programs stored thereon can be loaded onto one or more different computers or other processors to implement various aspects of the present invention as discussed above.

The terms “program” or “software” are used herein in a generic sense to refer to any type of computer code or set of computer-executable instructions that can be employed to program a computer or other processor to implement various aspects of the present invention as discussed above. Additionally, it should be appreciated that according to one aspect of this embodiment, one or more computer programs that when executed perform methods of the present invention need not reside on a single computer or processor, but may be distributed in a modular fashion amongst a number of different computers or processors to implement various aspects of the present invention.

Computer-executable instructions may be in many forms, such as program modules, executed by one or more computers or other devices. Generally, program modules include routines, programs, objects, components, data structures, etc. that perform particular tasks or implement particular abstract data types. Typically the functionality of the program modules may be combined or distributed as desired in various embodiments.

Also, data structures may be stored in computer-readable media in any suitable form. For simplicity of illustration, data structures may be shown to have fields that are related through location in the data structure. Such relationships may likewise be achieved by assigning storage for the fields with locations in a computer-readable medium that conveys relationship between the fields. However, any suitable mechanism may be used to establish a relationship between information in fields of a data structure, including through the use of pointers, tags or other mechanisms that establish relationship between data elements.

Various aspects of the present invention may be used alone, in combination, or in a variety of arrangements not specifically discussed in the embodiments described in the foregoing and is therefore not limited in its application to the details and arrangement of components set forth in the foregoing description or illustrated in the drawings. For example, aspects described in one embodiment may be combined in any manner with aspects described in other embodiments.

Also, the invention may be embodied as a method, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

Also, the phraseology and terminology used herein is for the purpose of description and should not be regarded as limiting. The use of “including,” “comprising,” or “having,” “containing,” “involving,” and variations thereof herein, is meant to encompass the items listed thereafter and equivalents thereof as well as additional items.

What is claimed is:

1. A computer storage medium having computer-executable modules thereon, the modules comprising:
a command processing shell adapted to receive a plurality of dynamically specified commands and invoke one or more task modules adapted to execute tasks that fulfill the received commands, wherein a portion of the commands is related to transaction processing, and the command processing shell is adapted to:
track an ambient transaction in response to commands of the portion related to transaction processing; and
commit a transaction in response to commands of the portion related to transaction processing.

2. The computer storage medium of claim 1, wherein the command processing shell is adapted to receive the plurality of commands through a user interface or from a script file.

3. The computer storage medium of claim 1, wherein the portion of the commands related to transaction processing comprises a start transaction command, an undo transaction command and a complete transaction command.

4. The computer storage medium of claim 1, wherein the portion of the commands related to transaction processing further comprises a start nested transaction command.

5. The computer storage medium of claim 1, wherein the command processing shell is adapted to provide information relating to a state of the transaction processing to the task modules.

6. The computer storage medium of claim 5, wherein the information about the state of the transaction processing comprises an indication of whether an ambient transaction exists.

7. The computer storage medium of claim 1, wherein the command processing shell further comprises:
a transaction stack module adapted to maintain information identifying an ambient transaction and nested transactions.

8. A computer storage medium having computer-executable modules thereon, the modules comprising:
one or more task modules adapted to execute when invoked by a command processing engine, wherein at least a portion of the one or more task modules is a transacted task module adapted to execute in a transacted environment, the transacted task modules each comprising:
an instruction to obtain information identifying a previously defined current transaction when the transacted task module is invoked within the current transaction; and
at least one transactional instruction to be executed within the context of the identified current transaction.

9. The computer storage medium of claim 8, wherein the one or more transacted task modules is free of computer executable instructions that cause a transaction to be committed.

10. The computer storage medium of claim 8, wherein the one or more transacted task modules comprises a conditional instruction identifying a block of transactional instructions to be conditionally executed based on state information associated with transaction processing.

11. The computer storage medium of claim 8, wherein the one or more transacted task modules each comprises a block of transacted computer-executable instructions.

12. The computer storage medium of claim 11, wherein at least a portion of the one or more transacted task modules each comprises a block of computer-executable instructions that is not transacted.

13. The computer storage medium of claim 12, wherein the one or more transacted task modules each comprises a parameter having a value indicating that the task module supports transactions.

14. A method of operating a computing device comprising a command shell, the method comprising:
receiving through the command shell a first command indicating a start of a transaction;
in response to the first command, identifying an ambient transaction;
while in the ambient transaction, receiving through the command shell a second command, the second command being a transacted command;
performing the second command in the context of the ambient transaction;
receiving through the command shell a third command indicating a disposition of the ambient transaction; and
in response to the third command, executing actions to effect the indicated disposition of the ambient transaction.

15. The method of claim 14, wherein receiving through the command shell a second command while in the ambient transaction, comprises receiving a plurality of transacted commands while in the ambient transaction, and transacted commands of the plurality of transacted commands indicate transacted actions on a plurality of different resources.

16. The method of claim 14, wherein:
receiving the first command comprises receiving a start command while a prior ambient transaction exists and the first command indicates a start of a nested transaction; and
identifying an ambient transaction in response to the first command comprises creating a record of a nested transaction.

17. The method of claim 16, wherein executing actions to affect the indicated disposition of the ambient transaction comprises disposing of the ambient transaction created in response to the first command and restoring the prior ambient transaction.

18. The method of claim 14, wherein:
receiving the first command comprises receiving a start command while a prior ambient transaction exists and the first command indicates a start of a non-nested transaction; and
identifying an ambient transaction in response to the first command comprises identifying that the ambient transaction is the prior ambient transaction and recording an indication of an additional subscriber to the ambient transaction.

19. The method of claim 18, wherein:
receiving a third command comprises receiving a command indicating that the ambient transaction should be completed; and
executing actions to effect the indicated disposition of the ambient transaction comprises reducing the indicated number of subscribers to the ambient transaction without completing the transaction.

20. The method of claim 19, wherein:
receiving the first command, the second command and the third command comprises receiving the first command, the second command and the third command from a script file or through a user interface.
